(19) United States
(12) Patent Application Publication
(10) Pub. No.: US 2013/0132852 A1
(43) Pub. Date: May 23, 2013

(54) INTERACTIVE PRESENTATION SYSTEM AND METHOD

(71) Applicant: Felipe Julian Sommer, Aventura, FL (US)

(72) Inventor: Felipe Julian Sommer, Aventura, FL (US)

(21) Appl. No.: 13/303,720

(22) Filed: Nov. 23, 2011

(51) Int. Cl. G06F 3/01; G06F 15/173

(52) U.S. Cl. 715/736

(57) ABSTRACT

An interactive presentation system is presented herein. In particular, the system comprises a central presentation management device disposed in a communicative relation with a plurality of mobile participation devices via a communication network. The system further includes at least one presentation display disposed in a communicative relation with said central presentation management device and structured to display presentation media thereon at least during an active presentation. An auxiliary presentation module is displayed or presented to the participant devices for acceptance of an input or communication from the participant. The presentation management device is structured to receive and analyze the inputs, in real-time, and in some embodiment, automatically augment the presentation media based thereupon.

### BACKGROUND OF THE INVENTION

1. Field of the Invention

The present invention is generally directed to an interactive presentation system and method comprising at least one central presentation management device and a plurality of participant devices. Each of the participants (e.g., audience members, students, passersby, etc.) of the presentation are shown various main or primary presentation media, e.g., in the form of a slide show, picture(s) or video presentations, audio, etc., and are further periodically presented with auxiliary or interactive presentation media communicated to or otherwise displayed on the corresponding participant devices. In particular, the participants may provide interactive input by, for example, answering questions, completing problems, etc., on the participant devices in response to the auxiliary presentation media displayed thereon. The central presentation management device is structured to receive communications from the participant device(s) and generate real-time statistical information or other data corresponding to the inputs provided by the various participants. In addition, the main presentation media may be augmented or modified in real-time via the central presentation management device or hub, for example, based upon the one or more inputs provided by the participants.

2. Description of the Related Art

Presentations occur nearly everyday in a vast array of industries, especially in educational settings and class rooms, regardless of the age group or facility. In addition to class room presentations from teachers to students, presentations are given at trade shows to promote new products, by politicians to raise funds, campaign, or deliver news, etc. The problem, however, with most presentations is that they lack interactivity between the audience members (e.g., the students, disciples, etc.) and the presenter(s) (e.g., the teacher(s)). The communications are all too often unidirectional from the presenter to the audience members, meaning that the presenter talks and the audience listens.

The problem with this unidirectional communication should be readily apparent in that the audience members are generally not involved in the content or presentation and oftentimes become uninterested in the presentation overtime or become frustrated by the lack of ability to become involved and voice her or her opinion or concern. In addition, the presenter will often like to monitor the status of certain audience members, particularly in the educational setting. For example, the teacher may want to monitor a student's answers to a test or quiz in real time, and monitor the pace or speed the student takes a test or quiz.

Accordingly, there is a need in the art to transform the static audience members into participants by creating an interactive presentation system and method. The proposed system and method would include a plurality of computer or electronic participant devices disposed in a communicative relation with at least one management device or hub, for instance, via a wireless communication network. The participants may interact with certain presentation media or content which the management device or presenter can monitor and communicate with in real-time, or otherwise immediately upon receipt of the input. The presenter may use or control the management device or hub directly, or, in at least one embodiment, may use a separate presentation or control device disposed in a communicative relation with the management device and/or the participant device(s).

### SUMMARY OF THE INVENTION

The present application is generally directed to a new interactive presentation system and method. In particular, the presentation system and method is structured to enhance the presentation experience for the presenter and the participants by making it easier for the participants to become involved and by augmenting certain presentation media in real-time based upon, for example, a participant's input, answer, or other communications during the active presentation.

Specifically, the system comprises at least one central presentation management device and/or hub, such as a computing device (including a laptop, notebook, mobile computer, tablet computer, iPad, iPod, iPhone, cellular telephone, desktop computer, etc.) disposed in a communicative relation with a plurality of participation devices (including a laptop, notebook, mobile computer, tablet computer, iPad, iPod, iPhone, cellular telephone, desktop computer, etc.) via a communication network. The presenter may use or communicate directly with the central management system in order to control or otherwise direct the presentation. In another embodiment, however, the presenter may have a separate, preferably portable, control device which communicates with the management system and the participant devices. Either way, the present invention comprises a dashboard or unique presenter application (executed or accessed by the management system or the control device) which the presenter accesses and is provided with real-time information, data and/or statistics of what is going on in the class. The presenter may, via the dashboard, view and select participant-generated content and push the content to a display screen.

In particular, the system comprises at least one presentation display screen disposed in a communicative relation with the central presentation management device. The presentation display of the various embodiments is structured to display presentation media (e.g., text, images, video, audio, slideshows, etc.) thereon at least during an active presentation. In certain embodiments, the presentation display is part of or displayed on each of the individual participant devices. Although, in other embodiments, the presentation display instead or in addition includes a separate display panel, such as a monitor, projection screen, etc.

Furthermore, certain auxiliary presentation modules are displayed or activated on the participant devices or display screen throughout the presentation in order to prompt the participant to generate an input or other communication. The auxiliary modules can include virtually any interactive modules (including games) and accept virtually any input, such as touchscreen writing, typing via a keypad, free text inputs, gestures, multiple choice answers, generating questions back to the presenter, and any other inputs, etc.

In addition, the main presentation media may be augmented, in real-time, in response to the participant's input or communication (e.g., through the auxiliary module). For instance, when the management device receives the user's input, the presentation media displayed to the participant devices or otherwise on the presentation display may be augmented. This allows for a collective and interactive presentation involving the participants and modifying the media as the presentation progresses. The various users, participants, presenters, etc., may send messages to one another, to a common display screen, etc.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a schematic representation of the interactive presentation system of at least one embodiment of the present invention.

FIG. 2A is a schematic representation of the interactive presentation system as disclosed in accordance with another embodiment of the present invention.

FIG. 2B is a schematic representation of yet another embodiment comprising a separate control device communicatively disposed with the hub and/or the participant device(s).

FIG. 3 is an exemplary representation of the management application of at least one embodiment.

FIG. 4 is another exemplary representation of the management application of the present invention.

FIG. 5 is a schematic representation of the management application of yet another embodiment as disclosed herein.

Like reference numerals refer to like parts throughout the several views of the drawings.

### DETAILED DESCRIPTION OF THE PREFERRED EMBODIMENT

As shown in the accompanying drawings, the present invention is directed to an interactive presentation system, generally referenced as 10. In particular, and as will be described in greater detail hereinafter, the interactive presentation system 10, as well as the various interactive, communicative, and/or media-based components thereof, is structured to dramatically enhance the experience at various presentations, including, but certainly not limited to educational presentations conducted by teachers to his or her students in various educational facilities, marketing presentations, presentations conducted at trade shows, political presentations, athletic presentations, pep-rally's, etc.

Specifically, the present invention is structured to enhance the involvement of the participants during the active presentation and allows the one or more presenters to at least partially control certain media displayed to each of the participants individually, by groups, or collectively. In addition, the system 10 of at least one embodiment of the present invention further provides the presenter with immediate, instantaneous, and/or real-time statistical analysis, communications, answers, etc. from the participants creating an enhanced experience for the presenter as well as each of the participants involved or present.

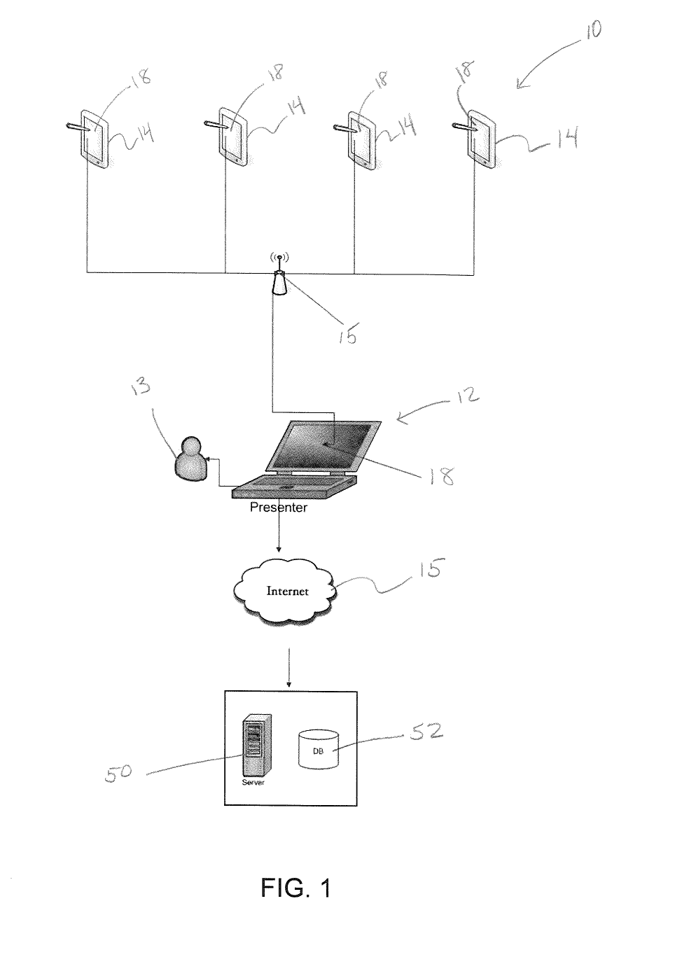

Specifically, and with reference to FIG. 1, at least one embodiment of the system 10 comprises a central presentation management system or device 12, such as a central hub, and a plurality of participant devices 14. In general, the central presentation management system 12 or hub is operated by or on behalf of the presenter 13 and, as will become apparent from the following discussion, is structured to at least partially manage or otherwise control the presentation, or at least a portion of the presentation. Furthermore, the various participant devices 14 are utilized by the participants of the presentation, such as, for example, the audience members, students, etc., in order to interact with the presentation and/or presentation media.

In particular, the central presentation management device 12 or hub of the various embodiments of the present invention can include any suitable interface or component structured to communicate with the participant devices (e.g., via a communication network 15), display certain presentation media, and/or manage certain presentation media and modules, as will be described below. Accordingly, the management device 12 can include virtually any type of electronic device, including a portable electronic device, such as, for example, a laptop computer, mobile computer or tablet computer, a hand-held or substantially portable multi-media device (such as an iPhone®, iPad®, iPod®, Blackberry®, a mobile device utilizing Android™, Windows Mobile® or other mobile-based operating systems, etc.), a personal data assistant (“PDA”), a cellular or mobile telephone, a video display or projection device, and/or a substantially fixed or stationary media device, such as a desktop computer.

Moreover, the management device 12 comprises a computer processor, a memory and/or storage device, communication circuitry and, in at least one embodiment, a display. Particularly, the computer processor can include any processing circuitry or processor operative to control or manage the various computer operations in order to facilitate the practice of the present invention as described herein. For instance, the computer processor (along with other components) may be used to run, access, and/or execute one or more various applications such as an operating system as well as the management application or participant application, as described herein. In addition, the storage device and/or memory device may include, for example, one or more storage mediums including a hard-drive, solid state drive, flash memory, permanent memory such as ROM, cache memory, RAM, and/or one or more different types of memory used for storing data, or any combination thereof. The communications circuitry may include any suitable communications circuitry operative to connect to a communication network 15 and to transmit and receive communications within the communication network 15. Accordingly, the management device 12 may interface with or communicate through one or more communication networks 15. In at least one embodiment, the communication circuitry of the management device 12 may be structured to generate, create or set up a communication network 15, utilizing, for example, BlueTooth, WiFi, or other communication protocols.

Furthermore, the management device 12 of at least one embodiment is structured to receive inputs and generate or communicate outputs to one or more other devices, including the various participant devices 14, one or more display devices 18, a separate presentation control device 2, etc. Accordingly, the management system 12 may include or comprise various video or image projection capabilities or communicate media to a video or image projection device.

Additionally, various participant devices 14 may include any suitable interface, device or component structured to communicate with the management devices 12 and/or the communication network 15. Accordingly, the participant devices 14 can include virtually any type of electronic device, including a portable electronic device, such as, for example, a laptop computer, mobile computer or tablet computer, a hand-held or substantially portable multi-media device (such as an iPhone®, iPad®, iPod®, Blackberry®, a mobile device utilizing Android™, Windows Mobile® or other mobile-based operating systems, etc.), a personal data assistant (“PDA”), a cellular or mobile telephone, and/or a substantially fixed or stationary media device, such as a desktop computer. The participant devices 14 may be the user's or participant's own device (such as the user's cellular telephone, laptop, iPad, etc.) or be handed out or otherwise provided to the participant for use during the corresponding presentation.

In any event, the participant devices 14 comprise a computer processor, a memory and/or storage device, communication circuitry and a display, similar to the components described above in regard to the management device 12. Moreover, the participant devices 14 include an interface or component for allowing a user or participant to communicate inputs thereto. The input interface may include, for example, but are in no way limited to a touch screen, one or more keys, key pads, buttons, dials, wheels, gesture input devices, cameras, microphones, etc.

Furthermore, the separate control device 2 of at least one embodiment may also include any suitable interface, device or component structured to communicate with the management devices 12, the communication network 15, and/or the various participant devices 14. Accordingly, the control device can include virtually any type of electronic device, preferably a portable electronic device, such as, for example, a tablet computer (e.g., an Apple iPad, Android tablet, etc.) or a laptop computer, mobile computer, hand-held or substantially portable multi-media device (such as an iPhone®, iPad®, iPod®, Blackberry®, a mobile device utilizing Android™, Windows Mobile® or other mobile-based operating systems, etc.), a personal data assistant (“PDA”), a cellular or mobile telephone, and/or a substantially fixed or stationary media device, such as a desktop computer. Either way, the control device 2 comprises a computer processor, a memory and/or storage device, communication circuitry and a display.

Moreover, the communication network(s) 15 identified herein may comprise any one or more networks structured to facilitate computer-to-computer communication or otherwise in order to facilitate practice of at least one embodiment of the present invention in the intended manner. Accordingly, the communication network 20 may comprise, for example, any local area network (“LAN”), wide area network (“WAN”), Bluetooth network, private or controlled network, the World Wide Web, Intranet, peer-to-peer network, cellular network, Third Generation Telecommunication network (“3G”), Fourth Generation Telecommunication network (“4G”), etc. As mentioned above, the management device 12 may be structured to create or generate a communication network 15 for use in connection with the present invention. Furthermore, a separate router or other communication device may be used to create, set up or establish a communication network.

Accordingly, the central management device 12 or hub may be connected to the Internet or other collection of networks allowing for the use of the present invention in remote settings or applications. Specifically, while in at least one embodiment, the various devices (including the participant devices, control device, and/or management device) may be located in a proximate location with one another (e.g., in the same room, building, auditorium, or otherwise within range of a short range, private or local network), etc. In one embodiment, however, the various devices (including the participant devices, control device, and/or management device) are disposed in remote locations to one another and connected to or communicable with one another via the Internet or wide network, for example.

Furthermore, the management device 12 and/or control device 2 of the various embodiments may be structured to execute, run, access, and/or display a presentation management application 20, at least during the course of an active presentation. The presentation management application may be stored on the management device 12, the control device 2, or accessed remotely or via a cloud network. In any event, and as will become apparent from the disclosure herein, the management application 20 comprises a plurality of features and functions that are utilized to assist with the implementation of the present invention, including, but in no way limited to communications with various participant devices 12, communications with a participant application, displays of media, information, and data (e.g., real-time statistical information, real-time communications, and real-time answers from participant devices), etc.

Additionally, the participant devices 14 are structured to execute, run, access and/or display a participant application, which may be stored and accessed locally on and by the participant device or accessed remotely via a network or cloud. In one embodiment, the participant application may be downloaded onto the participant device (e.g., a user's own cellular telephone, mp3 device or other hand-held multi-media device) or pre-loaded onto the device 14 and distributed to the various participants of the presentation. In any event, the participant application is structure to facilitate implementation of the various features of the present invention on or by the participant devices 14, as described herein.

Furthermore, an active presentation, as used herein, is defined as an exhibition, performance, or delivery of information, such as, in the form of a slide show, videos, text, audio, verbal speech, actions, or any combination thereof. The active presentation may be continuous, have short, minimal, extensive, numerous or long breaks, may be conducted in a close proximity or vicinity, or remotely through a communication network. The active presentation may be repetitive in that the presentation is given multiple, successive times over a given day, week, month, year or other time frame. Accordingly, the active presentation in accordance with the various embodiments of the present invention may be conducted in a classroom by a teacher to its students or disciples, at a trade show to potential customers, passersby, investors, etc., at a school's or athletic pep rally, by a coach to his or her athletes, etc. The participants (and the participant devices 14) may all be in a proximate location as the presenter (and the management device 12), such as, for example, within the same classroom, auditorium, locker room, building, room, park, stadium, etc. In another embodiment, however, one or more (or all) of the participants (and participant devices 12) may be disposed in a different location from one another and/or in a different location from the presenter (and the management device 12) and thus, the active presentation may take place at least partially though a wide area network, or the World Wide Web, Internet, etc.

More in particular, the present invention comprises presentation media, generally referenced at 30, displayed to each of the participants of the presentation, for example, on a presentation display 18. The presentation media includes any multi-media data or information structured to facilitate the presentation, such as, text, photos, images, drawings, video, animation, audio, and can include questions, polls, problems to be solved, etc. The presentation display 18 of at least one embodiment is part of or a component of the participant device(s) 14 in that the presentation media 30 may be communicated to and displayed directly on one or more of the participant devices 14. In particular, the participant devices 14 may be synchronized with the management device 12 in that the participant devices 14 display common presentation media 30 thereon and/or a common auxiliary presentation module 40, as described herein.

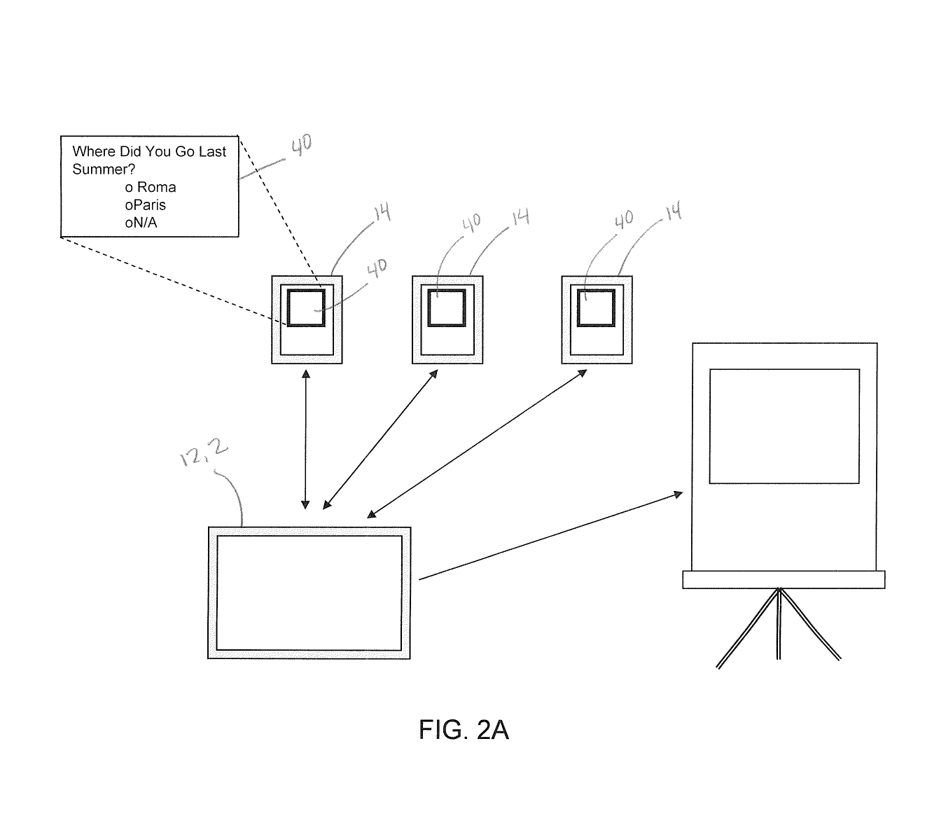

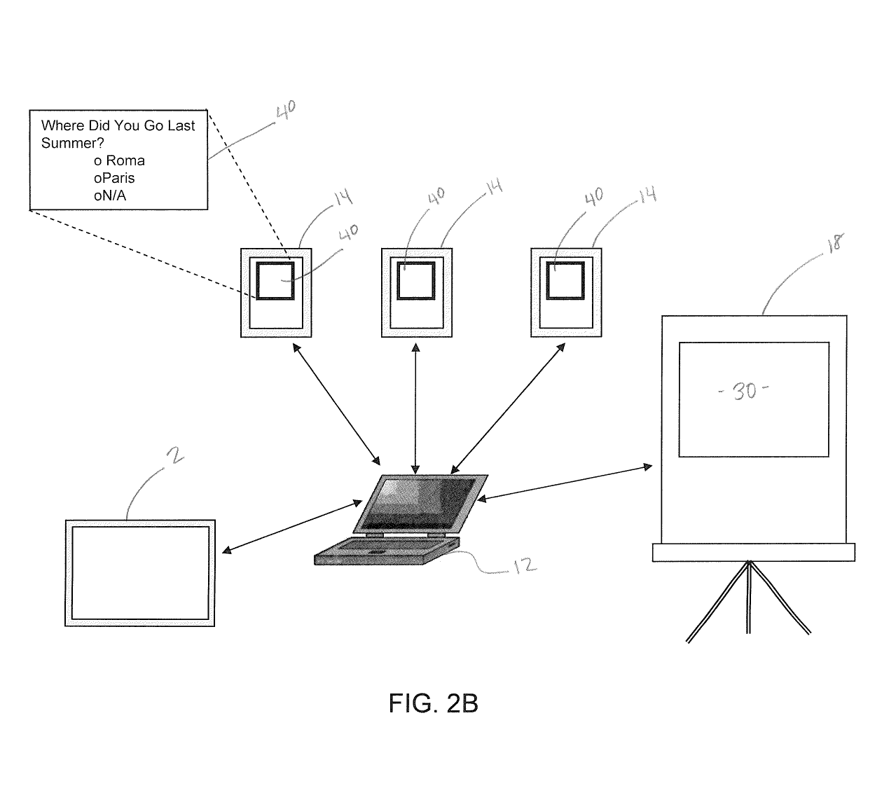

In other embodiments, however, and as shown in FIGS. 2A and 2B, the presentation display 18 may comprise a separate structure such as, for instance, a projection screen, monitor, display board, etc. which can be viewed by the participants either locally or remotely. In particular, the presentation display 18 of at least one embodiment is disposed in a communicative relation with the management device 12 in that the management device 12 is capable of controlling, managing or otherwise communicating the presentation media 30 to the presentation display 18.

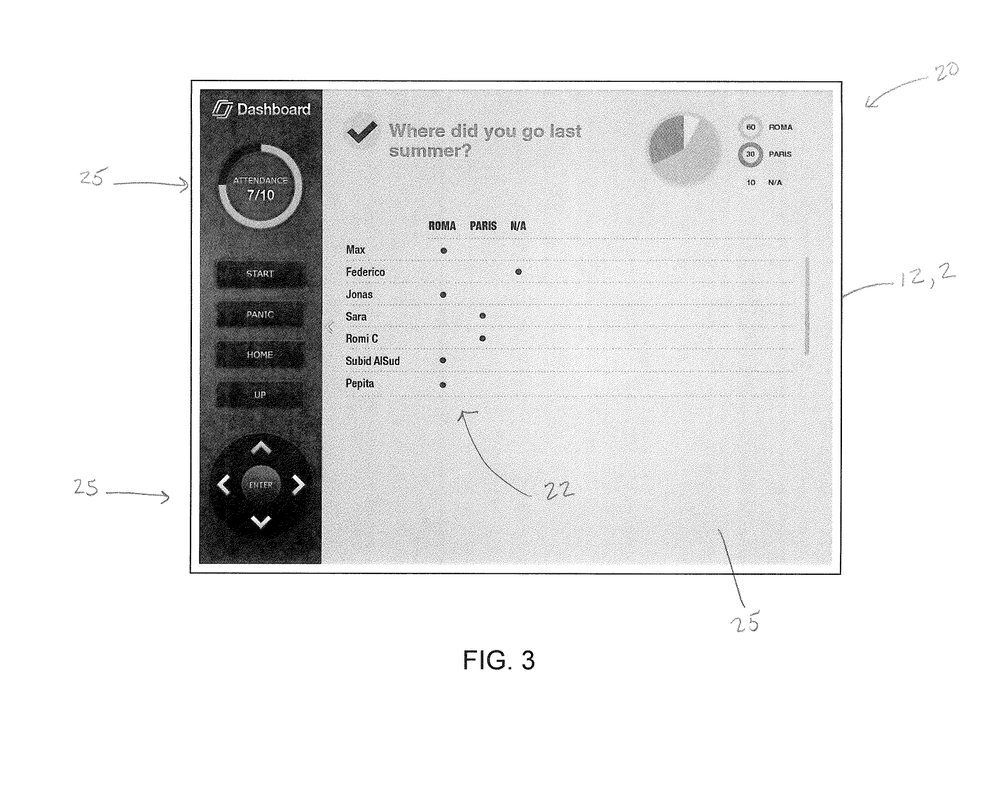

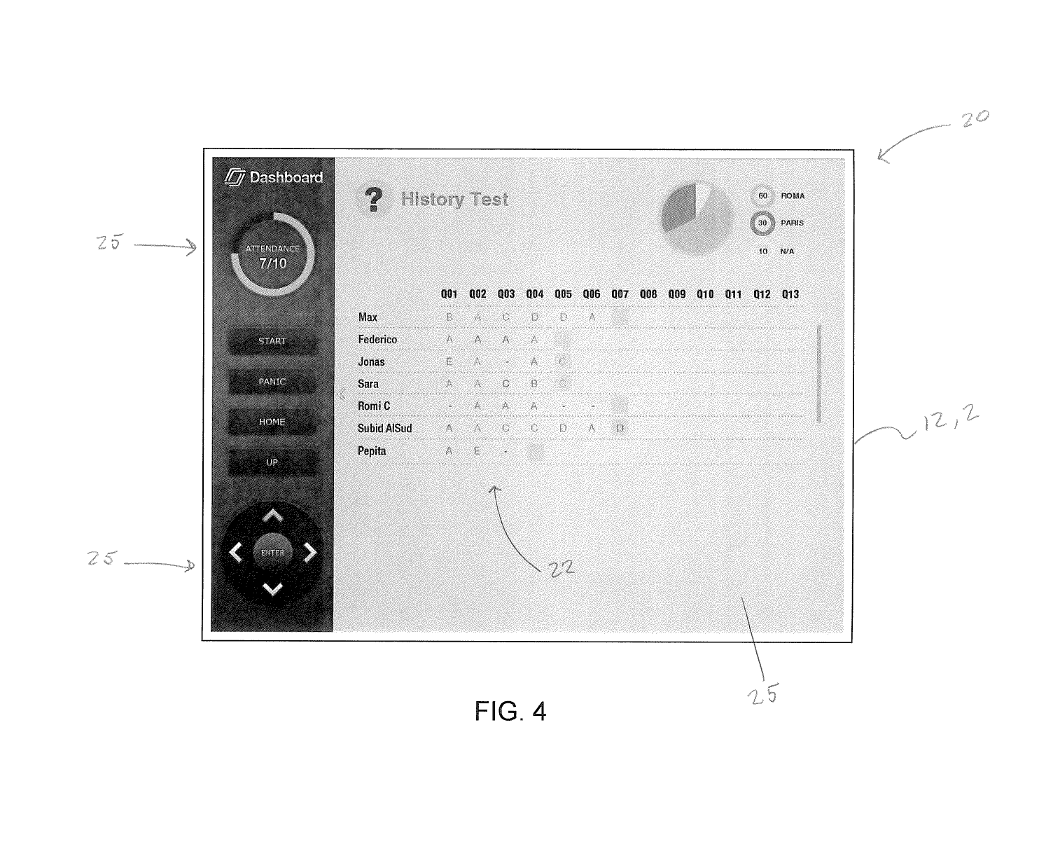

Referring now to FIG. 2B, in at least one embodiment, the system further comprises a control device 2, as described above. In particular, the control device 2 is disposed in a communicative relation with the central management device 12 and/or the various participant devices 14. In particular, the control device 2 is preferably a separate, portable tablet or component in which the presenter is able to control the presentation and the communication of media to the participant devices 14 and/or the display 18. Accordingly, the control device 2 is capable of executing, accessing or otherwise displaying a dashboard or application 20 (as exemplified in FIGS. 3 and 4). As described herein, the dashboard or application 20 of at least one embodiment comprises a display of one or more modules 25 unique to the presenter in that the presenter is able to view different screens, media and modules than the media that is displayed on the participant devices 14 and/or the display screen 18. This feature allows the presenter(s) to effectively control all aspects of the presentation, receive real-time updates or communications from the participant devices 14, and in at least one embodiment, select user or participant generated media and push the media to the display screen 18. The control device 2 may communicate directly with the participant device 14 or display screen 18 and/or may communicate with the participant devices 14 or display screen 18 via the central management device 12.

In addition, the participant application or participant devices 14 are structured to present or display an auxiliary presentation module 40 to the participant and accept an input from the participant based thereupon. For instance, the auxiliary presentation module 40 of the various embodiments of the present invention is structured to prompt or request an input from the participant at the participant device 14 and communicate the input to the management device 12 via the communication network 15. Specifically, however, the participant's input is communicated to the management device 12 and/or control device 2 in real-time, meaning that the input is immediately or instantaneously communicated to the presenter at the management device 12 or control device 2 upon submission of the input at the participant device 14. Accordingly, the participant is able to interact with the active presentation via the participant device 14, and the presenter is able to receive real-time communications from the participant's via the auxiliary presentation module 40.

In one embodiment, each of the participant devices 14 or a sub-group of participant devices 14 are synchronized with the management device 12 and all display a common auxiliary presentation module 40. As an example, in FIGS. 2A and 2B, the auxiliary presentation module 40 prompts the participants at the participant devices 14 to answer a question, namely, “Where did you go last summer?” The available answers, in this example, are “Roma,” “Paris,” and “N/A.” As shown in FIG. 3, the management application 20 or dashboard (accessible via the management device 12 or control device 2) is structured to receive the input(s) from the participants or participant device(s) 14 and establish real-time communication data 22 associated therewith. For instance, using the same example, the management application 20 illustrated in FIG. 3, shows the real-time statistical data 22 associated with the answers or inputs provided. In this example, there are seven (7) participants, each of which answer the question as indicated.

In other embodiments, the auxiliary presentation module 40 may proceed through a series of questions, prompts, or requests for input. In such a case, each of the participants at different participant devices 14 may proceed though the module 40 at a different speed or pace. As an example, FIG. 4 illustrates the management application 20, wherein the real-time communications or data 22 from the participant devices 14 include answers to questions Q01 through Q13. The various participants proceed at different speeds in that some are further along than others. On the management device 12, the presenter may be able to identify which answers are correct and which answers are incorrect, for example, by virtue of different coloring or font. In any event, the system 10 of present invention is structured to facilitate real-time communications of data 22 from the participant devices 14 to the management device 12, at least during an active presentation, such as an educational class, etc.

Of course, the auxiliary presentation module 40 (shown in FIG. 2) and the real-time communication data 22 (shown in FIGS. 3 and 4) are only examples, and it should be apparent that the various embodiments of the present invention may include many different forms of auxiliary modules 40 and resultant communication data 22. In particular, the auxiliary modules 40 may request any type or form of input or communications from the participants, including, but certainly not limited to, multiple-choice answers, hand-written (in electronic or touch pad form) communications, audio, video or text communications, typed communications on a keypad, etc. Similarly, the real-time communication data 22 displayed on or communicated to the management device 12 may take on various forms depending on the application, presentation, and/or the auxiliary module 40 presented to the participant devices 14.

Furthermore, the auxiliary module 40 may be preloaded into a particular participant application accessed or displayed by the participant devices 14, such that, at certain points in the presentation or when prompted by the presenter or participant, the pre-selected or pre-designed module 40 is presented to the participant. In a preferred embodiment, however, the management device 12 is disposed in a communicative relation with the participant devices 14 such that, when prompted by the presenter or when the presentation or presentation media 30 reaches a certain pre-selected point, the management device 12 will either communicate the module 40 to the participant devices 14 or participant application, or the management device 12 is structured to communicate a signal to the participant devices 14 or participant application to display a certain module 40.

Moreover, in at least one embodiment, the main presentation media 30, displayed or broadcasted to all of the participants or participant devices on the presentation display 18, may, at the presenter's discretion, be augmented or modified based upon the real-time communications or inputs provided by the participants or participant devices 14 in response to or by virtue of the auxiliary presentation module 40, described above. Turning back to the same example given above, the presentation media 30 may include the communications, answers or inputs 22 provided by the participants. Accordingly, the main presentation display 18 and/or the media displayed thereon may be augmented or modified, in real-time based upon one or more of the participant's inputs provided. In one embodiment, the presentation media 30 is augmented in real-time and/or immediately upon receipt of the input(s) provided. However, in other embodiments, the management application 20 may first display or communicate the input(s) to the presenter, e.g., via the management device 12 or control device 2, who can then decide whether to augment or modify the main presentation media 30.

Particularly, in the embodiment wherein the auxiliary module 40 requests free-hand user input, gesture input, free text inputs, free typed user input, or otherwise provide the participant with broad discretion as to the input provided (as opposed to a closed input request such as a multiple choice option), the presenter may want to prescreen or otherwise selectively augment the communications prior to broadcasting the input(s) to the other participants.

Furthermore, the central presentation management device 12 or control device 2 of at least one embodiment is structured to allow the designation of a selected one or more of the participant devices 14 as being capable of augmenting the presentation media 30 or otherwise as being capable of providing a response or input to the auxiliary module 40. For instance, the presenter at the management device 12 may designate or “lock in” certain participant devices 14 as being able to provide an input to the auxiliary module 40. This may be done in a number of different ways, including, only sending or activating the auxiliary module to select participant devices 12, sending or activating different modules 40 for different participant devices 14, etc. As an example, the presenter or other individual at the management device 12 or control device 2 may “lock in” only those participants with a certain last name, with the first name “John,” with a name beginning with a certain letter, of a certain age or age range, having a certain background or profile, etc. In this way, the presenter can actively control the questions, polls, problems, etc. as desired.

In this regard, the management device 12, control device 2, and/or management application 20 may privately communicate with or interact with one or more of the participant devices 14 in a number of manners without broadcasting the communications or interactions to the other participants via the presentation media 30. In particular, at least one embodiment of the present invention contemplates “vertical” interaction between the teacher and student or between the presenter and the participant. The presenter at the management device 12 or control device 2 may select one or more participants or participant devices to communicate with and send direct, real-time media communications, in the form of text, video, audio, photos, images, etc., to one another or within a selected group. When a selected group of participants are involved, each participant may view the communications (unless otherwise specified). This feature is especially attractive in educational settings where the teacher can privately educate students and hone in on each the student's particular needs.

Furthermore, in yet another embodiment, the various participant devices 14 are disposed in a communicative relation with one another or with selected groups of participant devices 14. In this regard, the participants may work with one another on various group projects, group problems, etc. and communicate a single communication or input to the management device 12 or control device 2 per group or sub-group.

In addition, the presentation media 30 may be augmented or modified by the presenter at the management device 12 or control device 2, as well. As an example, the presentation media 30 may comprise an electronic book, en electronic article, or other media. The presenter may highlight or underline certain portions of the media 30 during the course of the active presentation. Of course, the presenter may augment other media 30, including by circling or marking on photos, images, video clips, etc.

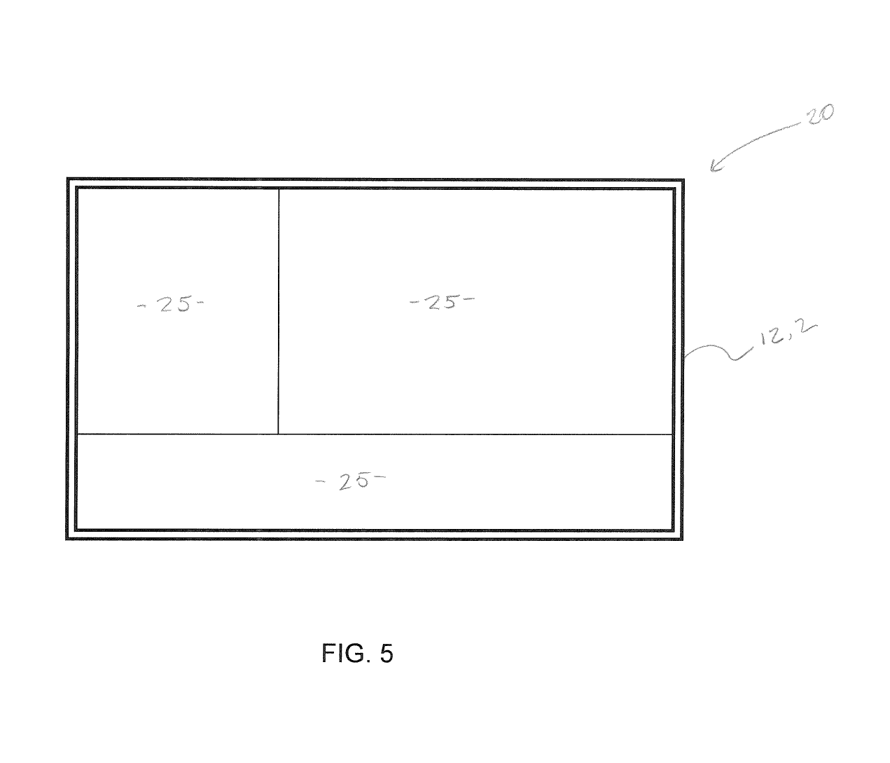

Referring to the general schematic of the management application 20 shown in FIG. 5, at least one embodiment comprises a plurality of management modules or displays 25 simultaneously available by the presenter during the active presentation. For example, the management modules may comprise a real-time statistical or communication display which is structured to display the various communications and inputs obtained from the one or more participant devices 14, as well as statistical data or other analysis of the inputs, for example, in the form of charts, graphs, statistics, etc. Accordingly, in at least one embodiment the management device 12 and/or the management application 20 is structured to analyze the inputs or other real-time communications 22 and transform the data into easily viewable and identifiable depictions, such as charts, graphs, or other interpretations of data.

Furthermore, at least one of the management modules 25 comprises a presentation media display 18, which is structured to display the presentation media 30 and/or augmented presentation media to the presenter. As described above, the presentation display 18 may, instead or in addition, comprise a separate display or screen.

Yet another management module 25 may also include a control module or control screen comprising a plurality of control buttons which, when activated, are structured to manage the presentation media 30. For example, the control module may comprise navigation buttons structured to allow the presented to advance the presentation to the next screen or slide, go back to a previous screen or slide, or otherwise manage the delivery of the presentation media 30.

In a further embodiment of the present invention, it should be noted that a presenter may create his or her own content or presentation media 30 as well as his or her own auxiliary presentation modules 40 for use in connection with the system 10 as described above. For instance, the content may be initially created in any format (e.g., Microsoft PowerPoint format, etc.) and converted into a format that can be read and is optimized for use with the management device 12, participant device(s) 14, and the corresponding management and participant applications. The content, e.g., the presentation media 30, may be stored on a remote server 50, a remote database 52 or other remote location and accessed by the management device 12 and/or participant devices 14. It should be noted that that presentation media 30 and auxiliary modules 40 may be downloaded prior to or during the presentation or maintained and accessed at the remote location via the Internet or other communication network 15.

Additionally, in one embodiment, the system comprises a security code or security system structured to minimize or eliminate unauthorized use of the system 10, unauthorized uploading of certain (unapproved) media to the remote location 50,52, etc. For example, the presentation media 30 and/or auxiliary modules 40 of at least one embodiment of the present invention comprises an embedded security code or identification which must be authenticated or otherwise approved before the presentation media 30 and/or modules 40 can be used with the system 10. Specifically, the management device 12, control device 2 (and/or management application 20) or the participant device 14 (and/or participant application) is structured to check or authenticate the presentation media 30 or module 40 in order for the system 10 to proceed. The check or authentication may occur prior to the presentation, at first access of the media 30 or modules 40, randomly throughout the presentation, periodically throughout the presentation, etc.

In addition, when a user creates his or her own content for the presentation, the newly created content must contain the authorization or security code in order to proceed. This code may be embedded into the newly presented content, for example, during conversion of the content in to the appropriate format, during creation of the content (e.g., if an authorized or pre-approved creation software application is used), etc. Specifically, any presentation media 30 or auxiliary module 40 used in connection with at least one embodiment of the present system 10 must comprise an authorization code or security code in order to proceed.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. An interactive presentation system, comprising:
a central presentation management device disposed in a communicative relation with at least one communication network, said central presentation management device comprising a computer processor and a storage device,
a plurality of mobile participant devices disposed in a communicative relation with the at least one communication network, each of said plurality of mobile participant devices comprising a computer processor and a memory device,
said participant devices being structured to display a participant application at least during an active presentation, and said central presentation management device being structured to display a presentation management application at least during the active presentation, and
said central presentation management device being disposed in a communicative relation with each of said plurality of mobile participant devices via the communication network, and said central presentation management device being structured to receive real-time feedback communications from said plurality of mobile participant devices, at least during the active presentation.

2. The interactive presentation system as recited in claim 1 wherein said plurality of mobile participant devices and said central management device are disposed in a proximate location with one another.

3. The interactive presentation system as recited in claim 2 wherein said participant application is structured to display an auxiliary presentation module on the corresponding mobile participant device and receive an input associated therewith.

4. The interactive presentation system as recited in claim 3 wherein each of said plurality of mobile participant devices are synchronized with said central presentation management device to simultaneously display a common auxiliary presentation module.

5. The interactive presentation system as recited in claim 3 wherein each of the plurality of mobile participation devices are structured to independently proceed through a plurality of questions presented.

6. The interactive presentation system as recited in claim 3 wherein said real-time feedback communications comprise real-time information relating to said input received by a corresponding one of said plurality of mobile participation devices.

7. The interactive presentation system as recited in claim 2 wherein said central presentation management device is structured to communicate in real-time directly with a selected one of said plurality of mobile participant devices.

8. The interactive presentation system as recited in claim 2 wherein said central presentation management system is structured to communicate in real-time directly with a selected sub-group of said plurality of mobile participant devices.

9. The interactive presentation system as recited in claim 2 wherein each of said plurality of mobile participant device are disposed in a real-time communicative relation with one another in order to collaboratively interact with the active presentation.

10. The interactive presentation system as recited in claim 2 wherein at least one selected sub-group of said plurality of participant devices are disposed in a real-time communicative relation with one another in order to collaboratively interact with the active presentation.

11. The interactive presentation system as recited in claim 2 wherein said presentation management application comprises and is structured to display a plurality of management modules on said central presentation management device; said plurality of management modules comprising at least one real-time statistical display and at least one presentation display.

12. The interactive presentation system as recited in claim 11 wherein said at least one real-time statistical display is structured to present said real-time statistical feedback communications from said plurality of mobile participant devices.

13. The interactive presentation system as recited in claim 12 wherein said at least one presentation display is structured to display on said central presentation management device a presentation media communicated to said plurality of mobile participant devices.

14. An interactive presentation system, comprising:
a central presentation management device disposed in a communicative relation with a plurality of mobile participant devices via a communication network, said central presentation management device and each of the plurality of mobile participant devices each comprising a computer processor and a storage device,
at least one presentation display disposed in a communicative relation with said central presentation management device and structured to display presentation media thereon at least during an active presentation,
a participant application displayed on each of the mobile participant devices at least during an active presentation, said participant application being structured to present an auxiliary presentation module and accept an input from a participant based upon said auxiliary presentation module,
a presentation management application displayed on a separate control device at least during the active presentation, said separate control device being disposed in a communicative relation with said central presentation management device, said presentation management application being structured to receive, in real-time, said input accepted by said participant application, and
wherein said presentation media displayed on said at least one presentation display is capable of being augmented based at least in part upon said input accepted by said participant application.

15. The interactive presentation system as recited in claim 14 wherein said presentation media is automatically and instantaneously augmented upon said input being accepted by said participant application.

16. The interactive presentation system as recited in claim 14 wherein said presentation media is selectively augmented upon receipt of said input by said central presentation management device.

17. The interactive presentation system as recited in claim 14 wherein said separate control device is disposed in a communicative relation with each of said plurality of mobile participant devices via the communication network, and wherein said presentation management application is structured to receive and display real-time statistical feedback communications from said plurality of mobile participant devices, at least during the active presentation.

18. The interactive presentation system as recited in claim 14 wherein said presentation display is separate from each of the plurality of mobile participant devices and said central presentation management device.

19. The interactive presentation system as recited in claim 14 wherein each of the plurality of mobile participation devices comprise said at least one presentation display.

20. The interactive presentation system as recited in claim 14 wherein said central presentation management device and the plurality of mobile participant devices are disposed in a proximate location to one another, at least during the active presentation.

21. The interactive presentation system as recited in claim 14 wherein said central presentation management device is structured to designate a selected one of the plurality of mobile participant devices as being capable of augmenting the presentation media displayed on said at least one presentation display.

22. The interactive presentation system as recited in claim 14 wherein said central presentation management device is structured to designate a selected sub-group of the plurality of mobile participant devices as being capable of augmenting the presentation media displayed on said at least one presentation display.

23. The interactive presentation system as recited in claim 14 wherein said presentation media comprises a security module authenticated by said central presentation management device.

24. The interactive presentation system as recited in claim 23 wherein said security module comprises an embedded security code combined with said presentation media.
